(19) United States
(12) Patent Application Publication
(10) Pub. No.: US 2026/0353387 A1
(43) Pub. Date: Nov. 5, 2026

(54) SUB-PRB LEVEL UL PRECODER CYCLING

(71) Applicant: Samsung Electronics Co., Ltd., Suwon-si (KR)

(72) Inventors: Mehmet Mert Sahin, Frisco, TX (US); Ahmad AIAmmouri, Plano, TX (US); Javad Abdoli, Plano, TX (US); Young Han Nam, Plano, TX (US)

(21) Appl. No.: 19/637,840

(22) Filed: Apr. 2, 2026

Related U.S. Application Data
(60) Provisional application No. 63/797,273, filed on Apr. 30, 2025.

(51) Int. Cl. H04W 72/1268; H04L 5/00; H04W 72/23; H04W 72/51

(52) U.S. Cl. CPC H04W 72/1268; H04L 5/0051; H04W 72/23; H04W 72/51

(57) ABSTRACT

A method of operating a base station (BS) includes receiving, from a user equipment (UE), a UE capability report indicating an antenna configuration of the UE, and transmitting, to the UE, a first message including a physical uplink shared channel (PUSCH) antenna port and precoder configuration for the UE. The method also includes transmitting, to the UE, a second message including uplink (UL) scheduling information and precoder cycling properties for the UE, and receiving, from the UE, at least one PUSCH transmission based on (i) the PUSCH antenna port and precoder configuration, (ii) the UL scheduling information, and (iii) the precoder cycling properties.

### CROSS-REFERENCE TO RELATED APPLICATION(S) AND CLAIM OF PRIORITY

This application claims priority under 35 U.S.C. § 119(e) to U.S. Provisional Patent Application No. 63/797,273 filed on Apr. 30, 2025. The above-identified provisional patent application is hereby incorporated by reference in its entirety.

### TECHNICAL FIELD

This disclosure relates generally to wireless networks. More specifically, this disclosure relates to sub-physical resource block (PRB) level uplink (UL) precoder cycling.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveforms (e.g., new radio access technologies [RATs]) to flexibly accommodate various services/applications with different requirements, new multiple access schemes to support massive connections, etc.

### SUMMARY

This disclosure provides apparatuses and methods for sub-PRB level UL precoder cycling.

In one embodiment, a method of operating a base station (BS) is provided. The method includes receiving, from a user equipment (UE), a UE capability report indicating an antenna configuration of the UE, and transmitting, to the UE, a first message including a physical uplink shared channel (PUSCH) antenna port and precoder configuration for the UE. The method also includes transmitting, to the UE, a second message including uplink (UL) scheduling information and precoder cycling properties for the UE, and receiving, from the UE, at least one PUSCH transmission based on (i) the PUSCH antenna port and precoder configuration, (ii) the UL scheduling information, and (iii) the precoder cycling properties.

In another embodiment, a method of operating a UE is provided. The method includes transmitting, to a BS, a UE capability report indicating an antenna configuration of the UE, and receiving, from the BS, a first message including a PUSCH antenna port and precoder configuration for the UE. The method also includes receiving, from the BS, a second message including UL scheduling information and precoder cycling properties for the UE, and transmitting, to the BS, at least one PUSCH transmission based on (i) the PUSCH antenna port and precoder configuration, (ii) the UL scheduling information, and (iii) the precoder cycling properties.

In yet another embodiment, an electronic device is provided. The electronic device includes at least on processor including processing circuitry, and memory storing instructions. The instructions, when executed by the at least one processor individually or collectively, cause the electronic device to receive, from a UE, a UE capability report indicating an antenna configuration of the UE, and transmit, to the UE, a first message including a PUSCH antenna port and precoder configuration for the UE. The instructions, when executed by the at least one processor individually or collectively, also cause the electronic device to transmit, to the UE, a second message including UL scheduling information and precoder cycling properties for the UE, and receive, from the UE, at least one PUSCH transmission based on (i) the PUSCH antenna port and precoder configuration, (ii) the UL scheduling information, and (iii) the precoder cycling properties.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

The following documents and standards descriptions are hereby incorporated by reference into the present disclosure as if fully set forth herein:
[1] 3GPP, “NR; Physical channels and modulation,” 3rd Generation Partnership Project, TS 38.211.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example antenna beamforming architecture according to embodiments of the present disclosure;

FIG. 5 illustrates an example non-codebook based UL transmission scheme for one transmission layer according to embodiments of the present disclosure;

FIG. 6 illustrates an example channel estimation according to embodiments of the present disclosure;

FIG. 7 illustrates an example procedure for activation of precoder cycling in a UE according to embodiments of the present disclosure;

FIG. 8 illustrates an example signal flow between a NW and UE to activate precoder cycling for the UE according to embodiments of the present disclosure;

FIG. 9 illustrates an example of sub-PRB level PUSCH precoding cycling with N-port PUSCH and rank-N PUSCH DMRS according to embodiments of the present disclosure;

FIG. 10 illustrates an example procedure for PUSCH generation and DMRS mapping performed according to a 1-port PUSCH and rank-1 PUSCH DMRS pattern according to embodiments of the present disclosure;

FIGS. 11-14 illustrate examples of UL precoder cycling when antenna selection is activated with PUSCH DMRS configuration type 1 according to embodiments of the present disclosure;

FIGS. 15-18 illustrate examples of UL precoder cycling when antenna selection is activated with PUSCH DMRS configuration type 2 according to embodiments of the present disclosure;

FIG. 19 illustrates an example method for sub-PRB level UL precoder cycling according to embodiments of the present disclosure; and

FIG. 20 illustrates another example method for sub-PRB level UL precoder cycling according to embodiments of the present disclosure.

### DETAILED DESCRIPTION

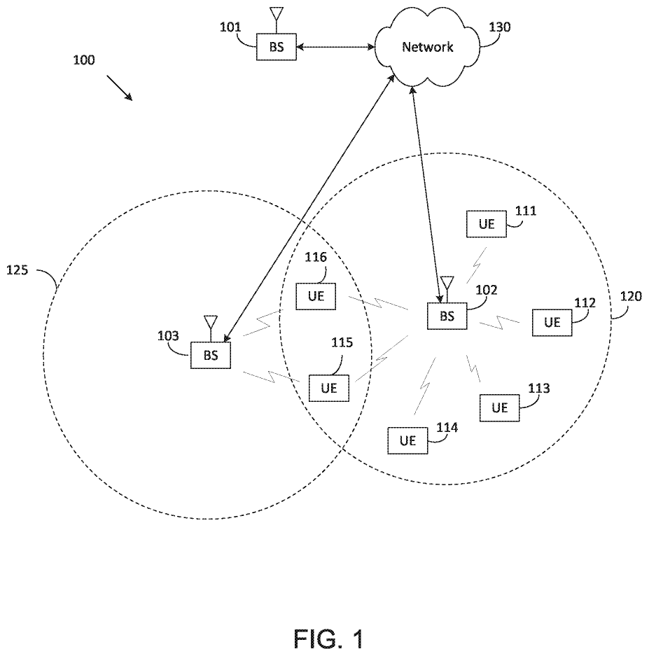

FIGS. 1 through 20, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for sub-PRB level UL precoder cycling. In certain embodiments, one or more of the gNBs 101-103 includes circuitry, programing, or a combination thereof, to support sub-PRB level UL precoder cycling in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

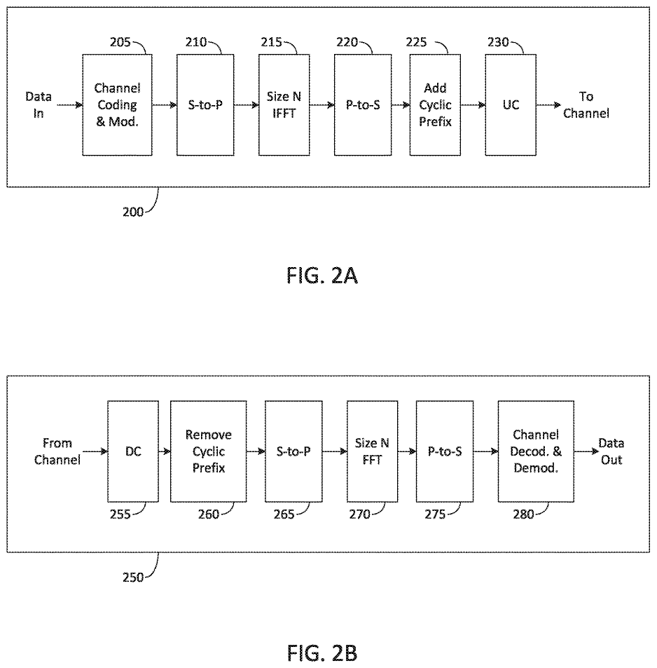

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support sub-PRB level UL precoder cycling as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted, and additional components can be added according to particular needs. Also, FIGS. 2A and 2B are meant to illustrate examples of the types of transmit and receive paths that can be used in a wireless network. Any other suitable architectures can be used to support wireless communications in a wireless network.

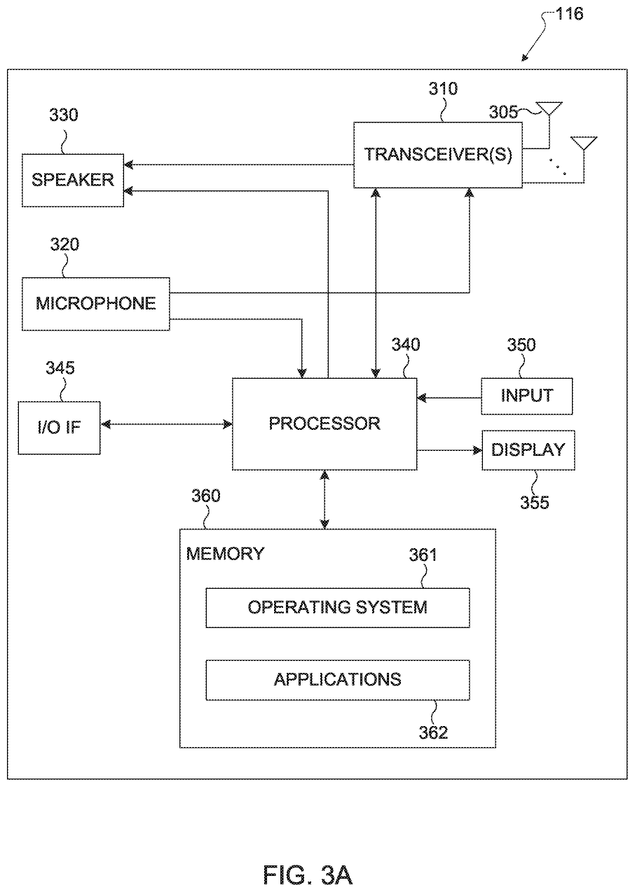

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for sub-PRB level UL precoder cycling as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support sub-PRB level UL precoder cycling as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted, and additional components could be added according to particular needs.

Rel. 13 LTE supports up to 16 CSI-RS antenna ports which enable a gNB to be equipped with a large number of antenna elements (such as 64 or 128). In this case, a plurality of antenna elements is mapped onto one CSI-RS port. Furthermore, up to 32 CSI-RS ports will be supported in Rel. 14 LTE. For next generation cellular systems such as 5G, it is expected that the maximum number of CSI-RS ports will remain more or less the same.

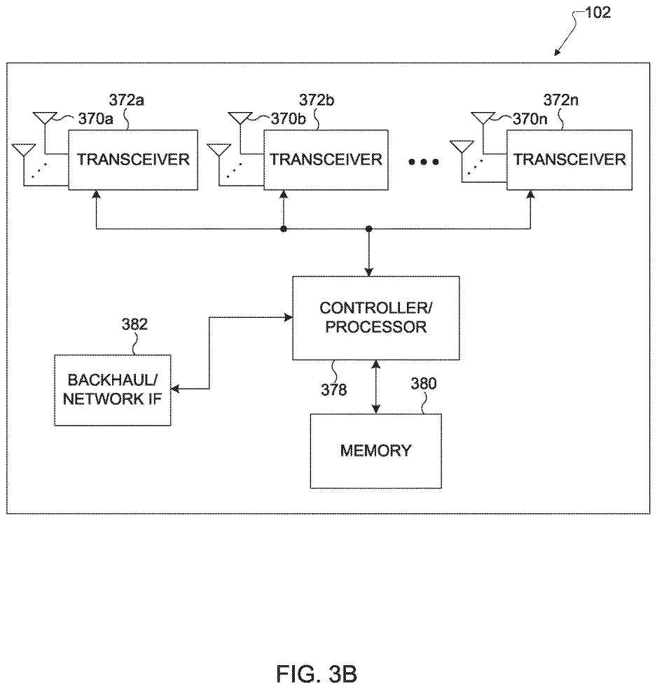

For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated by beamforming architecture 400 in FIG. 4.

FIG. 4 illustrates an example antenna beamforming architecture 400 according to embodiments of the present disclosure. The embodiment of the antenna beamforming architecture illustrated in FIG. 4 is for illustration only. Different embodiments of an antenna beamforming architecture could be used without departing from the scope of this disclosure.

In the example of FIG. 4, one CSI-RS port is mapped onto a large number of antenna elements which can be controlled by a bank of analog phase shifters 401. One CSI-RS port can then correspond to one sub-array which produces a narrow analog beam through analog beamforming 405. This analog beam can be configured to sweep across a wider range of angles 420 by varying the phase shifter bank across symbols or subframes or slots (wherein a subframe or a slot comprises a collection of symbols and/or can comprise a transmission time interval). The number of sub-arrays (equal to the number of RF chains) is the same as the number of CSI-RS ports N_{CSI-PORT}. A digital beamforming unit 410 performs a linear combination across N_{CSI-PORT} analog beams to further increase precoding gain. While analog beams are wideband (hence not frequency-selective), digital precoding can be varied across frequency sub-bands or resource blocks.

Although FIG. 4 illustrates one example antenna beamforming architecture 400, various changes may be made to FIG. 4. For example, various components in FIG. 4 could be combined, further subdivided, or omitted and additional components could be added according to particular needs.

As wireless communication systems operate on higher frequency bands, the transmission waveform is prone to higher Doppler effect. For example, under the assumption of the same subcarrier spacing (SCS), the Doppler effect for frequency range 3 (FR3) (7-8 GHz) is double that as compared to frequency range 1 (FR1) C-band. Moreover, current antenna/precoder selection techniques for UL-MIMO lack time-frequency diversity exploitation. The sounding reference signal (SRS) based antenna selection method suffers from SRS quality due to high-Doppler effect, and limited UE power. A more reliable open-loop diversity fallback scheme for MIMO UEs (2T4R, 4T8R) is desirable.

As a baseline, UL MIMO may utilize one of the following precoding options:
1) Blind antenna selection: The UE blindly selects N TX antennas out of N_{TX} antennas. The advantage of blind antenna selection is easy implementation. However, blind antenna selection lacks time-frequency diversity exploitation.
2) SRS-based antenna selection: Based on 2-port SRSs, the network (NW) determines the antenna ports and signals the determined antenna ports to the UE. The advantage of SRS-based antenna selection is easy implementation, and that it has better performance than blind antenna selection. However, SRS-based antenna selection has dependency on SRS and there can be limited SRS quality due to high-Doppler effect, and limited UE power.
3) Non-codebook based UL MIMO precoder: Utilizing CSI-RS, the UE determines which precoders to use. The BS estimates CSI through precoded SRS and indicates to the UE to use the precoder for the physical uplink shared channel (PUSCH) through downlink control information (DCI). Among these options, non-codebook based UL MIMO precoder offers the best performance under favorable conditions. However, similar to option 2, this option has SRS dependency and incurs performance degradation when SRS quality is low. Moreover, the UE needs coherent antennas to implement this option.
4) Cyclic delay diversity (CDD): Different delay values are applied to TX chains. CDD provides frequency domain diversity. However, CDD performance varies depending on the delay samples and heavy optimization is needed to find the best pairs for delays, which incurs complexity. Additionally, CDD's performance degrades when UE antennas are correlated.

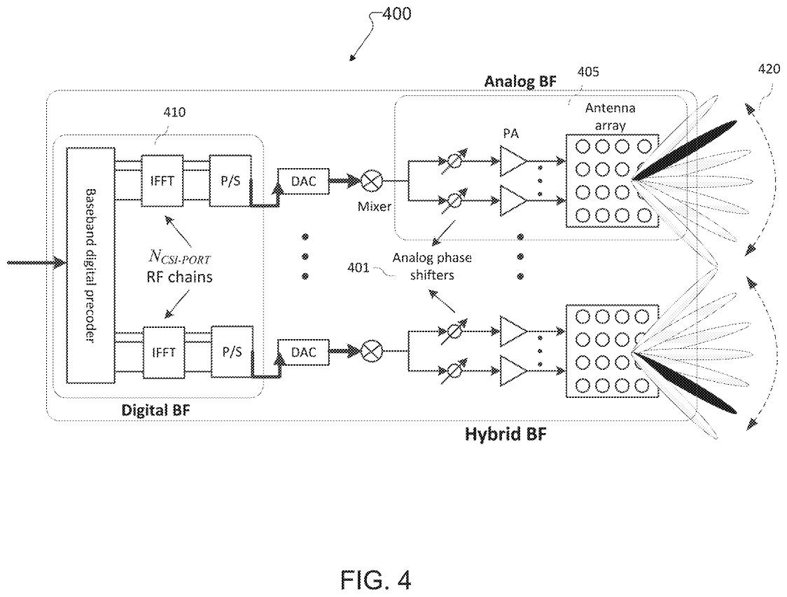

FIG. 5 illustrates an example non-codebook based UL transmission scheme for one transmission layer 500 according to embodiments of the present disclosure. The embodiment of a non-codebook based UL transmission scheme for one transmission layer of FIG. 5 is for illustration only. Different embodiments of a non-codebook based UL transmission scheme for one transmission layer could be used without departing from the scope of this disclosure.

In the example of FIG. 5, because only one transmission layer is configured, only one port is activated for both the PUSCH and the demodulation reference signal (DMRS) which are at the port 0. In this example, the UE applies a precoder to virtualize four antenna elements into one antenna port, where the precoder is represented as P. Similar as described in 3GPP TS 38.211, the following configurations are used to perform PUSCH and DMRS mapping in the example of FIG. 5:
PUSCH Mapping Type A, length=14 symbols
PUSCH DMRS Config Type 1, allocate every 2nd SC to DMRS,
Double Symbol DMRS,
dmrs-TypeA-Position=2,
dmrs-AdditionalPosition=1

Although FIG. 5 illustrates one example non-codebook based UL transmission scheme for one transmission layer 500, various changes may be made to FIG. 5. For example, various changes to mapping type could be made, etc., according to particular needs.

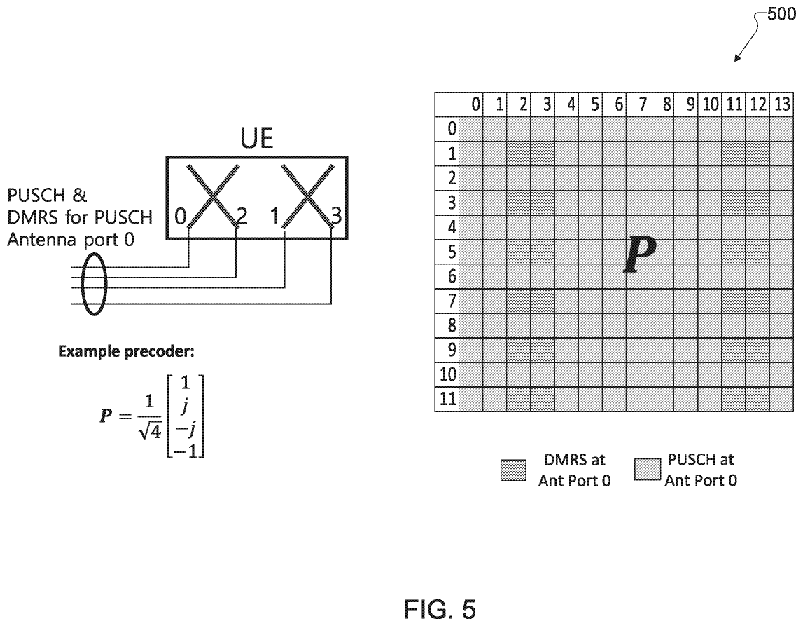

FIG. 6 illustrates an example channel estimation 600 according to embodiments of the present disclosure. The embodiment of channel estimation of FIG. 6 is for illustration only. Different embodiments of channel estimation could be used without departing from the scope of this disclosure.

In the example of FIG. 6, PUSCH and DMRS signals are transmitted from all physical antenna elements. Channel estimation at the network side is performed through a two-dimensional (2D) minimum mean square error (MMSE) filter.

Although FIG. 6 illustrates one example channel 600, various changes may be made to FIG. 6. For example, various changes to number of input DMRS RE's could be made, etc., according to particular needs.

Uplink transmissions suffer from reduced spectral efficiency and reliability because current systems primarily employ static or single precoders, failing to effectively address the time-varying and frequency-selective nature of wireless channels. The non-coherent antenna structure in the many existing UEs restricts the design and effectiveness of PUSCH precoders, hindering potential gains in spectral efficiency and reliability.

In PUSCH precoder cycling, the UE cycles different UL precoders or antennas for sub-bands (frequency division multiplexing [FDM]) and/or OFDM-symbols (time division multiplexing [TDM]). The UL precoder may be a UE antenna port selection, codebook-based transmitted precoding matrix indicator (TPMI), a non-codebook based precoder etc., for the selected precoder. For example, N UE TX antenna ports allow N antenna switching precoders.

Various embodiments of the present disclosure enhance UL spectral efficiency and coverage by enabling greater diversity opportunities in time-frequency fading and interference.

In some embodiments, sub-PRB level PUSCH precoder cycling is utilized to enhance UL spectral efficiency and coverage. With sub-PRB level PUSCH precoder cycling, the subcarriers comprising the PUSCH scheduling bandwidth are partitioned into groups of M consecutive subcarriers. Then N precoders are cyclically applied across the groups. In some embodiments, the precoder used for DMRS is the same as the precoder used for the PUSCH on the same subcarrier.

In some embodiments, signaling aspects for sub-PRB level PUSCH precoder cycling may include configuration through radio resource control (RRC), re-configuration through a medium access control (MAC) control element (CE), and indication through DCI (e.g., (DCI Format 0_0 or 0_1 or 0_2 or 0_3). Alternatively, in some embodiments, re-configuration may be through RRC. Alternatively, in some embodiments, indication may be through a MAC CE.

In some embodiments, a sub-PRB level PUSCH precoder cycling configuration may include one or more of the following:
A UE TX port configuration for UL precoder cycling through SRS ports
   This configures SRS ports on an SRS resource with non-coherent codebook usage
RRC signaling to configure UE with subcarrier level precoder cycling with following properties:
   PUSCH precoding type ({default, precoderCycling})
   Number of UE TX Antennas ({1, 2, 4})

In some embodiments, a sub-PRB level PUSCH precoder cycling re-configuration may be used to reconfigure the PUSCH precoding type and/or number of UE TX antennas.

In some embodiments, a sub-PRB level PUSCH precoder cycling indication may include one or more of the following:
Precoder type used for cycling: {antenna port selection, codebook based, non-codebook based}
Time-domain granularity:
   Option 1: OFDM symbol level
   Option 2: Transmission slot level
Frequency-domain granularity:
   Option 1: Subcarrier group length: defines how many subcarriers are allocated by one precoder, E.g., 1 or 2.
   Option 2: Group of RB size, E.g., 1, 2 or (Total # of RBs)/(UE UL Codebook size)
DMRS to RE mapping (optional): This information can be indicated to the UE explicitly or extracted from DMRS configuration parameters.
Cycling pattern (optional): Starting from the very beginning frequency assignment, the UE follows the cycling pattern among N possible precoders. E.g., (N=4), [1,2,3,4] or [2,4,1,3].

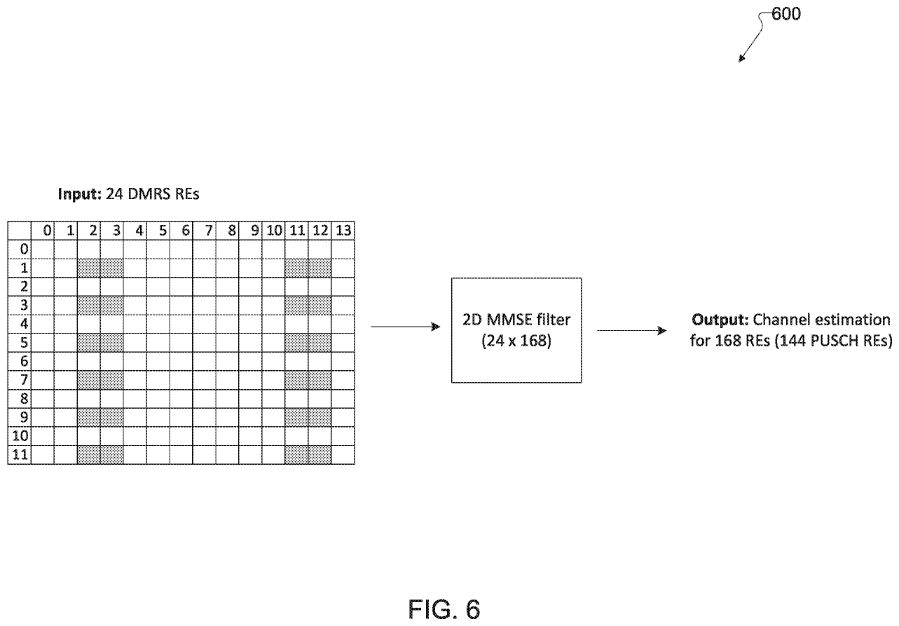

FIG. 7 illustrates an example procedure for activation of precoder cycling in a UE 700 according to embodiments of the present disclosure. An embodiment of the procedure illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a procedure for activation of precoder cycling in a UE could be used without departing from the scope of this disclosure.

In the example of FIG. 7, the procedure 700 begins at operation 710. At operation 710, a UE (such as UE 116 of FIG. 1) receives a configuration through RRC. For example, the configuration may be a PUSCH precoder cycling configuration as described herein.

At operation 720, the UE determines whether precoder cycling is activated. For example, if a PUSCH precoding type in the configuration is set to default, the UE may determine that precoder cycling is not activated. Alternatively, if a if a PUSCH precoding type in the configuration is set to precoderCycling, then the UE may determine that precoder cycling is activated. If the UE determines that precoder cycling is not activated, then procedure 700 proceeds to operation 730. Otherwise, if the UE determines that precoder cycling is activated, then procedure 700 proceeds to operation 750.

At step 730, the UE receives PUSCH scheduling information through DCI, but does not receive precoder cycling properties.

At step 740, the UE transmits PUSCH on resources allocated by the scheduling information at step 730.

At step 750, the UE receives PUSCH scheduling information and precoder cycling properties through DCI.

At step 760, the UE transmits PUSCH on resources allocated by the scheduling information at step 750 according to a precoder cycling pattern configured by the precoder cycling properties received at step 750.

Although FIG. 7 illustrates one example procedure for activation of precoder cycling in a UE 700, various changes may be made to FIG. 7. For example, while shown as a series of operations, various operations in FIG. 7 could overlap, occur in parallel, occur in a different order, occur any number of times, be omitted, or replaced by other operations.

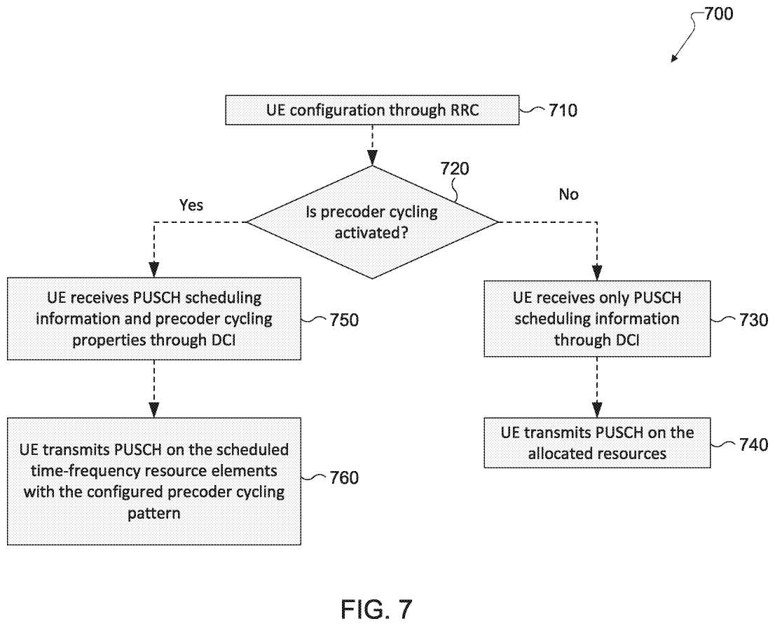

FIG. 8 illustrates an example signal flow between a NW and UE to activate precoder cycling for the UE 800 according to embodiments of the present disclosure. An embodiment of the signal flow illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a signal flow between a NW and UE to activate precoder cycling for the UE could be used without departing from the scope of this disclosure.

In the example of FIG. 8, the signal flow 800 begins at operation 810. At operation 810, UE 804 provides NW element 802 with a capability report including an indication of the antenna configuration of UE 804. For example, operation 810 may be performed as part of an initial access procedure (e.g., as defined in 5G NR).

Later, at operation 820, NW entity 802 configures PUSCH antenna ports and a precoder configuration through RRC for UE 804.

Once, there is a need for an UL transmission, at step 830, the NW entity 802 transmits UL scheduling information and precoder cycling properties through DCI on PDCCH.

At operation 840, the UE performs UL transmission based on the scheduling information and precoder cycling properties.

Although FIG. 8 illustrates one example signal flow between a NW and UE to activate precoder cycling for the UE 800, various changes may be made to FIG. 8. For example, while shown as a series of operations, various operations in FIG. 8 could overlap, occur in parallel, occur in a different order, occur any number of times, be omitted, or replaced by other operations.

In some embodiments, PUSCH generation and DMRS mapping may be performed according to an N-port PUSCH and rank-N PUSCH DMRS pattern. In embodiments such as these, The PUSCH is generated with one MIMO layer, whose modulation symbols are cyclically mapped to resource elements corresponding to N ports, according to the cyclic precoder mapping. In this case, the precoding granularity is still one PRB per port.

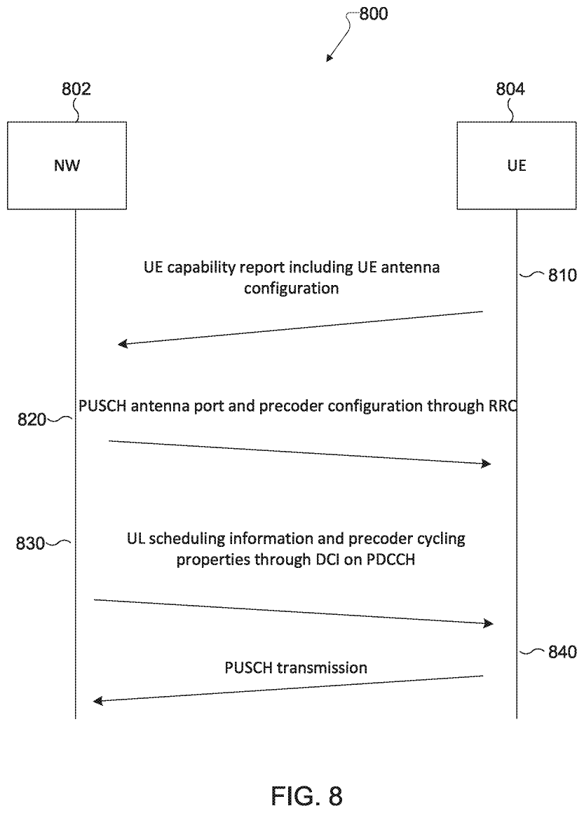

FIG. 9 illustrates an example of sub-PRB level PUSCH precoding cycling with N-port PUSCH and rank-N PUSCH DMRS 900 according to embodiments of the present disclosure. The embodiment of sub-PRB level PUSCH precoding cycling of FIG. 9 is for illustration only. Different embodiments of sub-PRB level PUSCH precoding cycling could be used without departing from the scope of this disclosure.

In the example of sub-PRB level PUSCH precoding cycling with N-port PUSCH and rank-N PUSCH DMRS of FIG. 9, N=4. Here, two consecutive subcarriers are grouped and different PUSCH data precoders are assigned to the groups. The antenna ports used for the groups are different among the groups. The example in FIG. 9 is specifically for antenna selection based precoder cycling where PUSCH is transmitted over different antennas for sub-PRB groups. However, this scheme is easily generalized to different UL precoder types including non-codebook, codebook, etc.

Although FIG. 9 illustrates one example of sub-PRB level PUSCH precoding cycling with N-port PUSCH and rank-N PUSCH DMRS 900, various changes may be made to FIG. 9. For example, various changes to the number of ports could be made, etc. according to particular needs.

In some embodiments, PUSCH generation and DMRS mapping may be performed according to a 1-port PUSCH and rank-1 PUSCH DMRS pattern which maps at least one DMRS RE per group. In embodiments such as these, the PUSCH is generated with one MIMO layer, whose modulation symbols are mapped to resource elements corresponding to one DMRS port. In this case, the precoding granularity is effectively reduced to M consecutive subcarriers per port.

In some embodiments, if a UE is configured with precoder cycling and antenna selection is activated, resource mapping for DMRS and PUSCH REs is indicated using following entities:
DMRS configuration type (e.g., Type 1 or Type 2)
Number of UE TX antenna for PUSCH

Using this information, the UE is able to extract DMRS to RE mapping for each precoder for PUSCH transmission. In some embodiments, a channel estimation module in the NW also extracts DMRS to RE mapping using DMRS configuration type, UE TX antenna number, and precoding cycling information elements. Alternatively in some embodiments, DMRS to RE mapping can be indicated to the UEs explicitly. In this configuration, DMRS resources are evenly shared with possible PUSCH precoders and/or antennas.

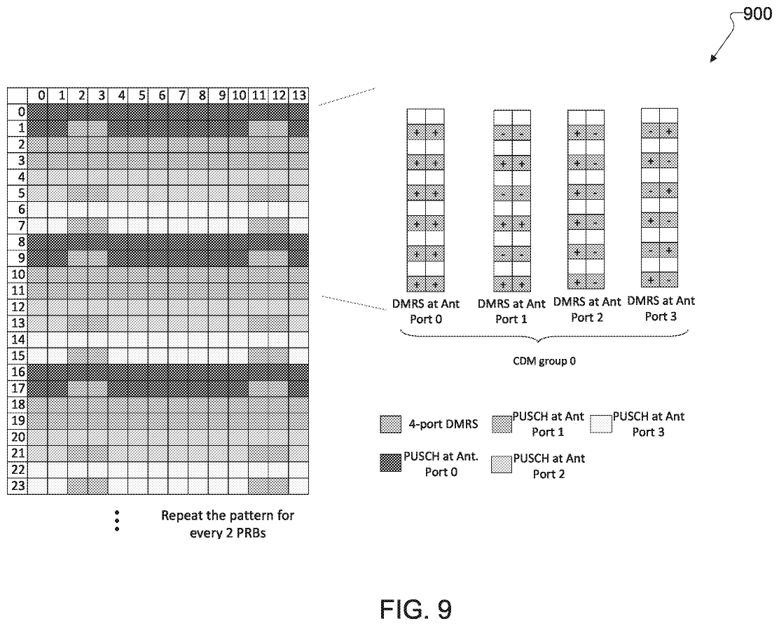

FIG. 10 illustrates an example procedure for PUSCH generation and DMRS mapping performed according to a 1-port PUSCH and rank-1 PUSCH DMRS pattern 1000 according to embodiments of the present disclosure. An embodiment of the procedure illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a procedure for PUSCH generation and DMRS mapping performed according to a 1-port PUSCH and rank-1 PUSCH DMRS pattern could be used without departing from the scope of this disclosure.

In example of FIG. 10, the procedure 1000 begins at operation 1010. At operation 1010, a UE (such as UE 804 of FIG. 8) determines a DMRS configuration type. For example, the DMRS configuration type may be included in a sub-PRB level PUSCH precoder cycling configuration. If the UE determines that the DMRS configuration type is Type 1, then the procedure proceeds to operation 1020. Otherwise, if the UE determines that the DMRS configuration is Type 2, then the procedure proceeds to operation 1030.

At operation 1020, the UE performs sub-PRB level PUSCH precoder cycling where the UE cycles over every subcarrier with a different precoder.

At operation 1030, the UE performs sub-PRB level PUSCH precoder cycling where two consecutive subcarriers are grouped, and a different precoder is assigned to groups with a periodicity of the number of possible precoders.

Although FIG. 10 illustrates one example procedure for PUSCH generation and DMRS mapping performed according to a 1-port PUSCH and rank-1 PUSCH DMRS pattern 1000, various changes may be made to FIG. 10. For example, while shown as a series of operations, various operations in FIG. 10 could overlap, occur in parallel, occur in a different order, occur any number of times, be omitted, or replaced by other operations.

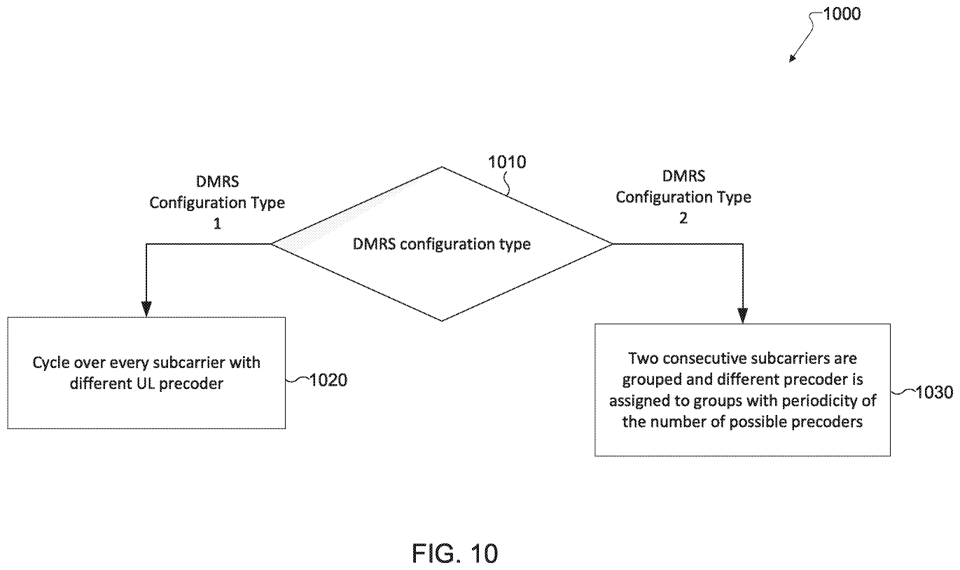

FIGS. 11-14 illustrate examples of UL precoder cycling when antenna selection is activated with PUSCH DMRS configuration type 1 1100-1400 according to embodiments of the present disclosure. The embodiments of UL precoder cycling of FIGS. 11-14 are for illustration only. Different embodiments of UL precoder cycling when antenna selection is activated with PUSCH DMRS configuration type 1 could be used without departing from the scope of this disclosure.

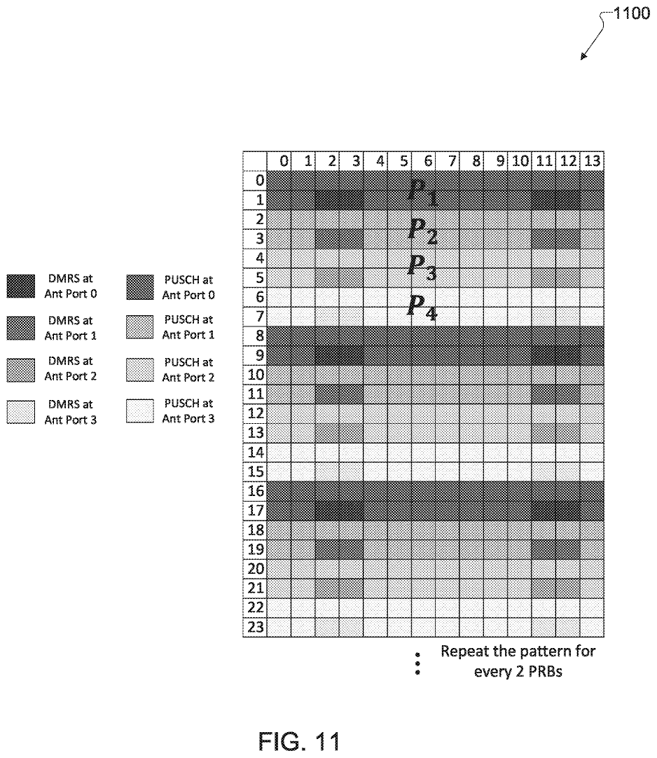

FIGS. 11 and 12 show OFDM slot level UL precoder cycling in the time domain. The difference between FIGS. 11 and 12 is that one pattern is sub-PRB level (FIG. 11), while the other is PRB level (FIG. 12) in the frequency domain. The dedicated DMRS configuration for these two particular patterns is listed as follows:
PUSCH Mapping Type A, length=14sym
PUSCH DMRS Config Type 1, allocate every 2nd SC to DMRS,
Double Symbol DMRS
dmrs-TypeA-Position=2
dmrs-AdditionalPosition=1

FIG. 11 depicts the sub-PRB level UL precoder cycling exemplified with antenna selection where the precoder codebook size is 4. PUSCH and DMRS at the first two subcarriers are transmitted with first precoder at the first port, the second group of subcarriers uses the second port transmitted by the second precoder, and so on. The pattern periodicity is the number of available precoders which is 4 in the example of FIG. 11.

FIG. 12 depicts the PRB level UL precoder cycling exemplified with antenna selection where the precoder codebook size is 4. PUSCH and DMRS at the first PRB are transmitted with first precoder at the first port, the second PRB uses the second port transmitted by the second precoder, and so on. The pattern periodicity is the number of available precoders which is 4 in the example of FIG. 12.

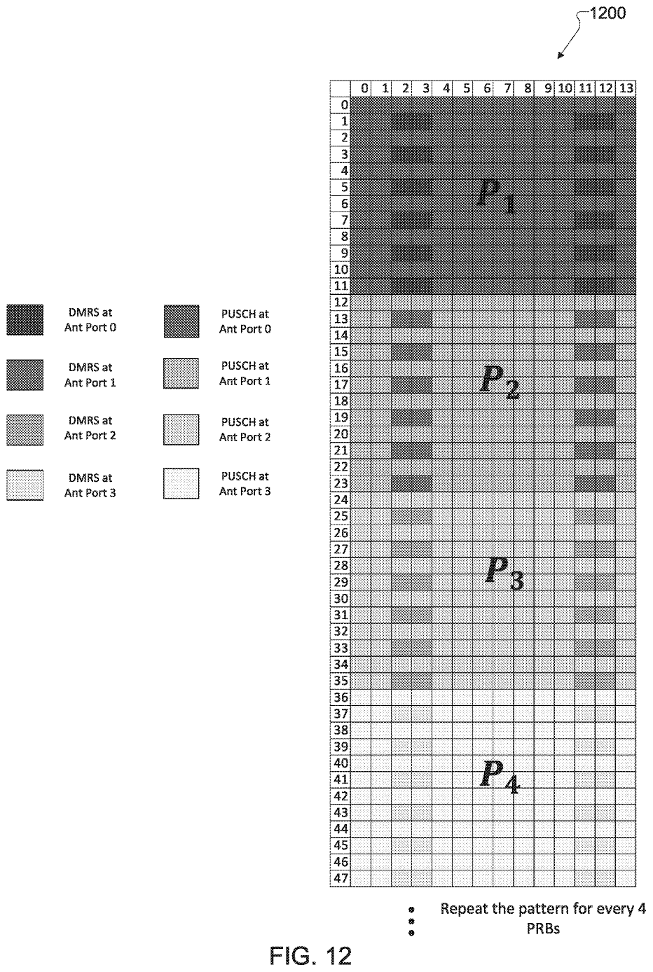

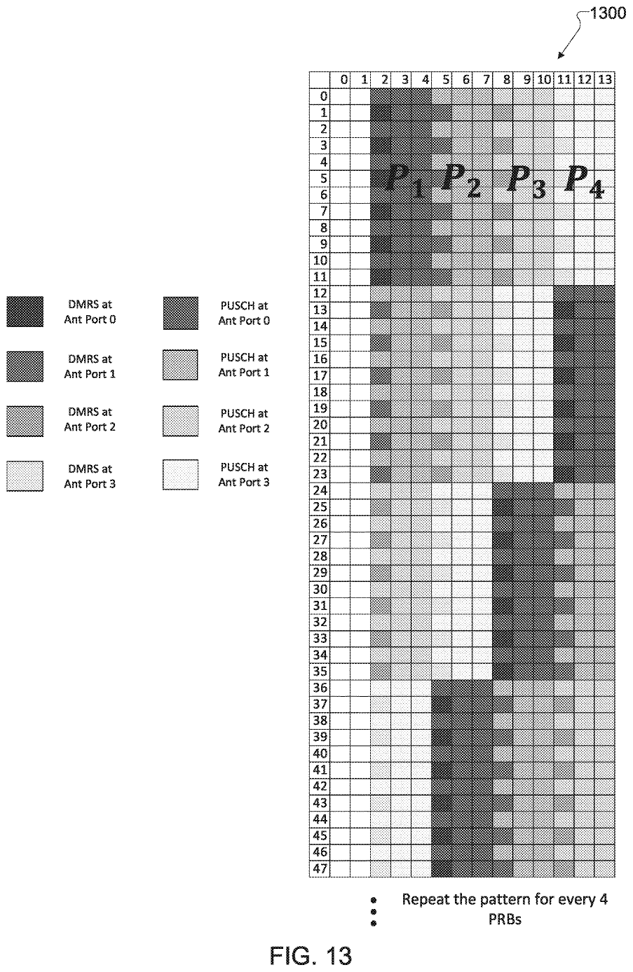

FIGS. 13 and 14 show sub-OFDM slot level UL precoder cycling in the time domain. The total number of OFDM symbols dedicated to UL transmission is grouped up to the number of possible precoders. The difference between FIGS. 13 and 14 is that one pattern is sub-PRB level (FIG. 14), while the other is PRB level (FIG. 13) in the frequency domain. The dedicated DMRS configuration for these two particular patterns is listed as follows:
PUSCH Mapping Type B, startingSymbol=2, length=12sym
PUSCH DMRS Config Type 1, allocate every 2nd SC to DMRS
Single Symbol DMRS
dmrs-AdditionalPosition=3

FIG. 13 depicts the PRB level UL precoder cycling exemplified with antenna selection where the precoder codebook size is 4. PUSCH and DMRS at the first PRB are transmitted with the first precoder at the first port, the second PRB uses the second port transmitted by the second precoder, and so on. Cycling also happens in the time domain similar to the frequency domain where the group size for a sub-OFDM slot group is 3 OFDM symbols. The pattern periodicity is the number of available precoders which is 4 in the example of FIG. 13.

FIG. 14 depicts the sub-PRB level UL precoder cycling exemplified with antenna selection where the precoder codebook size is 4. PUSCH and DMRS at the first two subcarriers are transmitted with the first precoder at the first port, the second group uses the second port transmitted by the second precoder, and so on. The pattern periodicity is the number of available precoders which is 4 in the example of FIG. 14.

Although FIGS. 11-14 illustrate examples of UL precoder cycling when antenna selection is activated with PUSCH DMRS configuration type 1 1100-1400, various changes may be made to FIGS. 11-14. For example, various changes to the codebook sizes could be made, etc., according to particular needs.

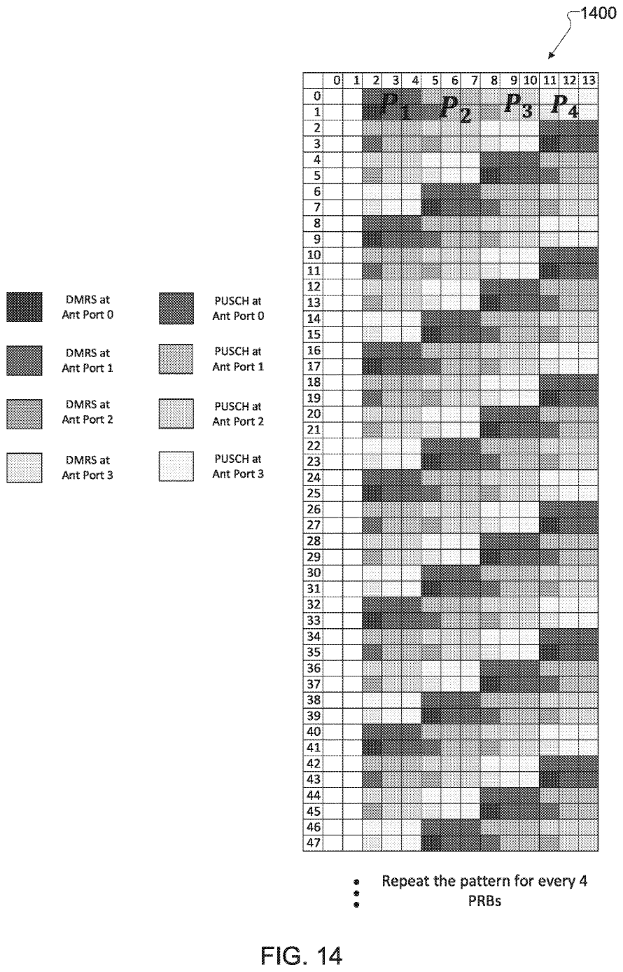

FIGS. 15-18 illustrate examples of UL precoder cycling when antenna selection is activated with PUSCH DMRS configuration type 2 1500-1800 according to embodiments of the present disclosure. The embodiments of UL precoder cycling of FIGS. 15-18 are for illustration only. Different embodiments of UL precoder cycling when antenna selection is activated with PUSCH DMRS configuration type 2 could be used without departing from the scope of this disclosure.

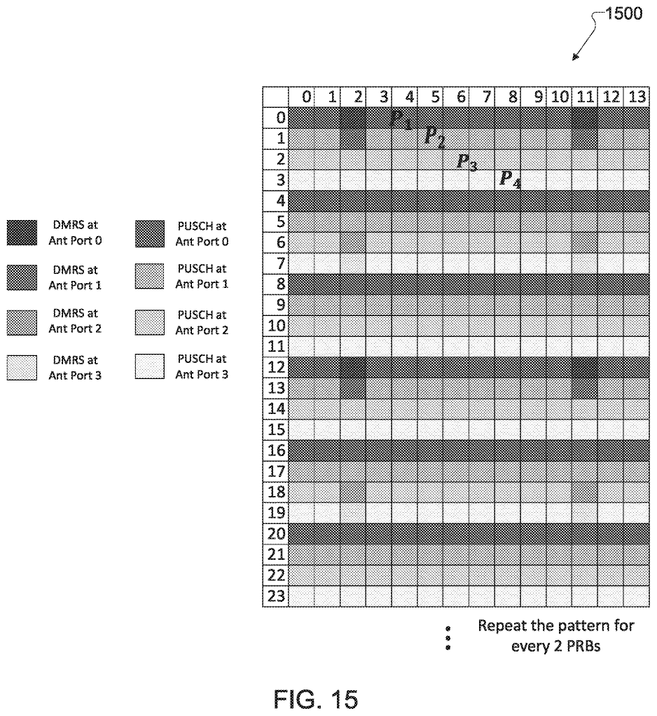

FIGS. 15 and 16 show OFDM slot level UL precoder cycling in the time domain. The difference between FIGS. 15 and 16 is that one pattern is sub-PRB level (FIG. 15), while the other is PRB level (FIG. 16) in frequency domain. The dedicated DMRS configuration for these two particular patterns is listed as follows:
PUSCH Mapping Type A, length=14sym
PUSCH DMRS Config Type 2, allocates every 3rd pair of SCs to DMRS,
dmrs-TypeA-Position=2
Single symbol DMRS
dmrs-AdditionalPosition=1

FIG. 15 depicts the sub-PRB level UL precoder cycling exemplified with antenna selection where the precoder codebook size is 4. PUSCH and DMRS at the first subcarrier are transmitted with the first precoder at the first port, the second subcarrier uses the second port transmitted by the second precoder, and so on. The pattern periodicity is the number of available precoders which is 4 in the example of FIG. 15.

FIG. 16 depicts the PRB level UL precoder cycling exemplified with antenna selection where the precoder codebook size is 4. PUSCH and DMRS at the first PRB are transmitted with first precoder at the first port, the second PRB uses the second port transmitted by the second precoder, and so on. The pattern periodicity is the number of available precoders which is 4 in the example of FIG. 16.

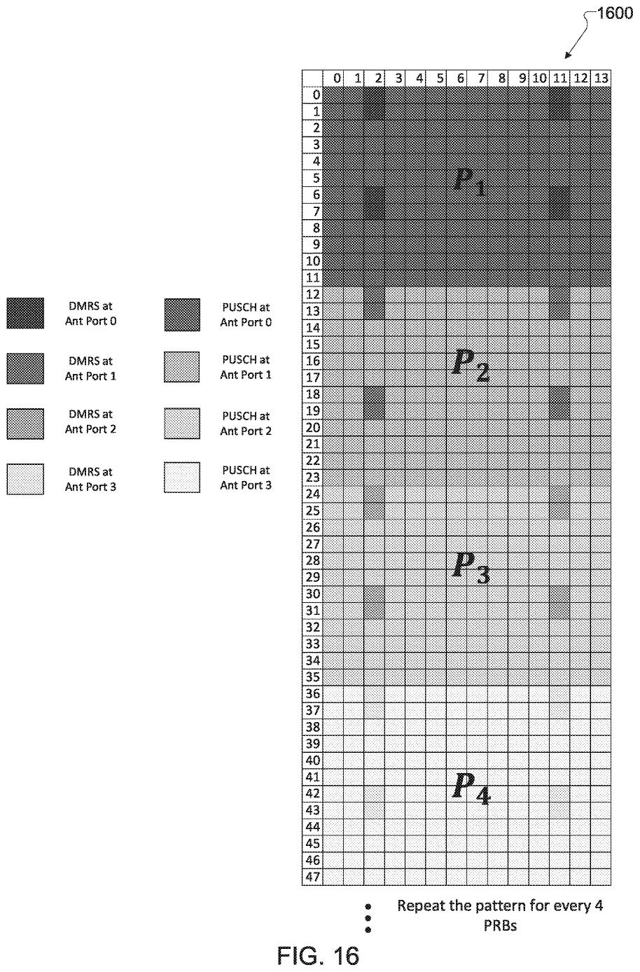

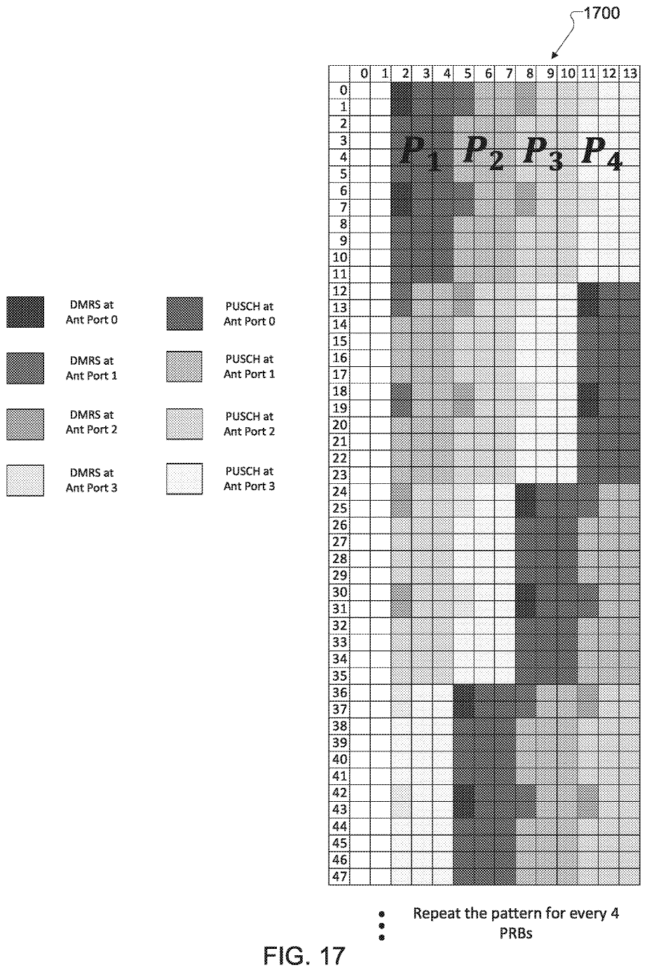

FIGS. 17 and 18 show sub-OFDM slot level UL precoder cycling in the time domain. The total number of OFDM symbols dedicated to UL transmission is grouped up to the number of possible precoders. The difference between FIGS. 17 and 18 is that one pattern is sub-PRB level (FIG. 18), while the other is PRB level (FIG. 17) in the frequency domain. The dedicated DMRS configuration for these two particular patterns is listed as follows:
PUSCH Mapping Type B, startingSymbol=2, length=12sym
PUSCH DMRS Config Type 2, allocates every 3rd pair of SCs to DMRS,
Single symbol DMRS
dmrs-AdditionalPosition=3

FIG. 17 depicts the PRB level UL precoder cycling exemplified with antenna selection where the precoder codebook size is 4. PUSCH and DMRS at the first PRB are transmitted with the first precoder at the first port, the second PRB uses the second port transmitted by the second precoder, and so on. The same cycling pattern happens in the time domain where the size of the sub-OFDM slot is 3 OFDM symbols. The pattern periodicity is the number of available precoders which is 4 in the example of FIG. 17.

FIG. 18 depicts the sub-PRB level UL precoder cycling exemplified with antenna selection where the precoder codebook size is 4. PUSCH and DMRS at the first subcarrier are transmitted with the first precoder at the first port, the second group uses the second port having the second subcarrier, and so on. The same cycling pattern happens in the time domain where the size of the sub-OFDM slot is 3 OFDM symbols. The pattern periodicity is the number of available precoders which is 4 in the example of FIG. 18.

Although FIGS. 15-18 illustrate examples of UL precoder cycling when antenna selection is activated with PUSCH DMRS configuration type 2 1500-1800, various changes may be made to FIGS. 15-18. For example, various changes to the codebook sizes could be made, etc., according to particular needs.

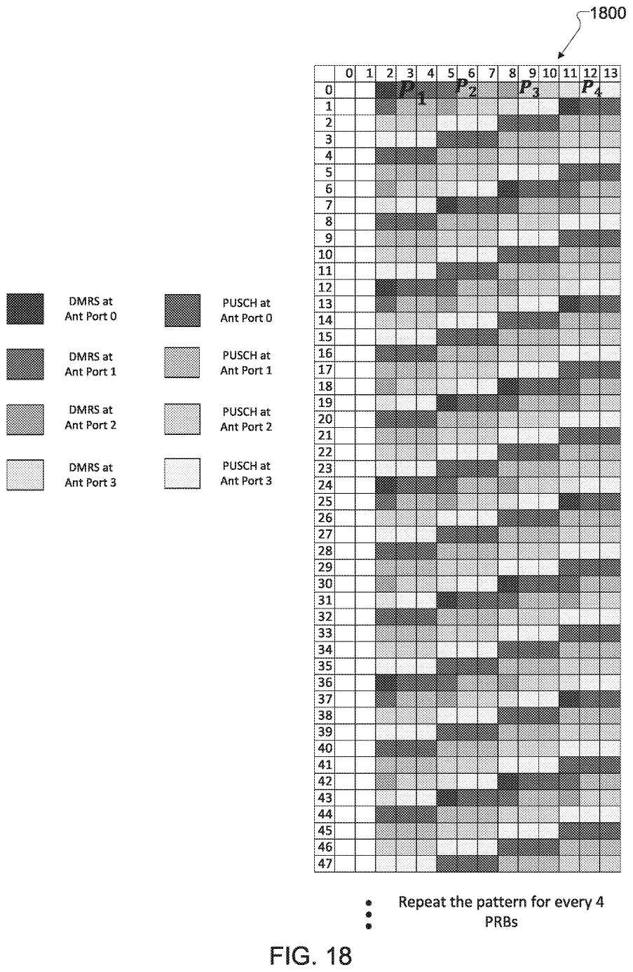

FIG. 19 illustrates an example method for sub-PRB level UL precoder cycling 1900 according to embodiments of the present disclosure. An embodiment of the method illustrated in FIG. 19 is for illustration only. One or more of the components illustrated in FIG. 19 may be implemented in specialized circuitry configured to perform the noted functions or one or more of the components may be implemented by one or more processors executing instructions to perform the noted functions. Other embodiments of a method for sub-PRB level UL precoder cycling could be used without departing from the scope of this disclosure.

In the example of FIG. 19, the method 1900 begins at step 1910. At step 1910, a BS (such as gNB 102 of FIG. 1) receives, from a UE (such as UE 116 of FIG. 1), a UE capability report indicating an antenna configuration of the UE.

At step 1920, the BS transmits, to the UE, a first message including a PUSCH antenna port and precoder configuration for the UE. In some embodiments, the first message may be an RRC message.

At step 1930, the BS transmits, to the UE, a second message including UL scheduling information and precoder cycling properties for the UE. In some embodiments, the second message may be a DCI message.

In some embodiments, the precoder cycling properties may include at least one of a precoder type used for precoder cycling, a time-domain granularity, a frequency-domain granularity, a DMRS to RE mapping, and a cycling pattern.

In some embodiments, where the precoder cycling properties include the precoder type, the precoder type may be one of an antenna selection precoder, a codebook based precoder, or a non-codebook based precoder.

In some embodiments, where the precoder cycling properties include the time-domain granularity, the time-domain granularity may be one of an OFDM symbol level granularity or a transmission slot level granularity.

In some embodiments, where the precoder cycling properties include the frequency-domain granularity, the frequency-domain granularity may be one of a subcarrier group length granularity, and a group of RB size granularity.

In some embodiments, where the precoder cycling properties include the DMRS to RE mapping, the DMRS to RE mapping may be one of (i) an N-port PUSCH and rank-N PUSCH DMRS pattern mapping, where N is an integer greater than 1, and (ii) a 1-port PUSCH and rank-1 PUSCH DMRS pattern mapping.

At step 1940, the BS receives, from the UE, at least one PUSCH transmission based on (i) the PUSCH antenna port and precoder configuration, (ii) the UL scheduling information, and (iii) the precoder cycling properties.

Although FIG. 19 illustrates one example method for sub-PRB level UL precoder cycling 1900, various changes may be made to FIG. 19. For example, while shown as a series of steps, various steps in FIG. 19 could overlap, occur in parallel, occur in a different order, occur any number of times, be omitted, or replaced by other steps.

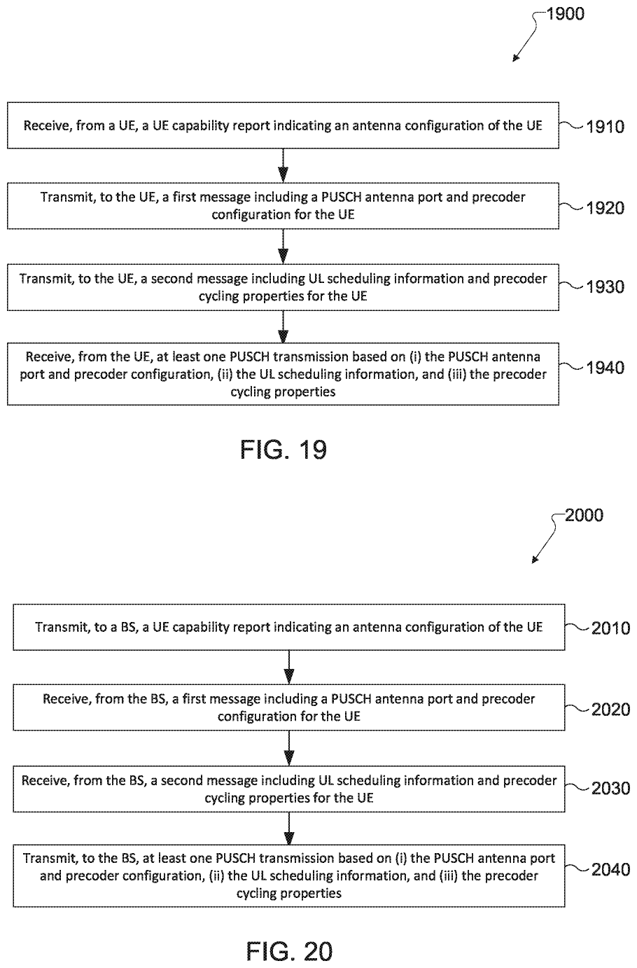

FIG. 20 illustrates another example method for sub-PRB level UL precoder cycling 2000 according to embodiments of the present disclosure. An embodiment of the method illustrated in FIG. 20 is for illustration only. One or more of the components illustrated in FIG. 20 may be implemented in specialized circuitry configured to perform the noted functions or one or more of the components may be implemented by one or more processors executing instructions to perform the noted functions. Other embodiments of a method for sub-PRB level UL precoder cycling could be used without departing from the scope of this disclosure.

In the example of FIG. 20, the method 2000 begins at step 2010. At step 2010, a UE (such as UE 116 of FIG. 1) transmits, to a BS (such as gNB 102 of FIG. 1), a UE capability report indicating an antenna configuration of the UE.

At step 2020, the UE receives, from the BS, a first message including a PUSCH antenna port and precoder configuration for the UE. In some embodiments, the first message may be an RRC message.

At step 2030, the UE receives, from the BS, a second message including UL scheduling information and precoder cycling properties for the UE. In some embodiments, the second message may be a DCI message.

In some embodiments, the precoder cycling properties may include at least one of a precoder type used for precoder cycling, a time-domain granularity, a frequency-domain granularity, a DMRS to RE mapping, and a cycling pattern.

In some embodiments, where the precoder cycling properties include the precoder type, the precoder type may be one of an antenna selection precoder, a codebook based precoder, or a non-codebook based precoder.

In some embodiments, where the precoder cycling properties include the time-domain granularity, the time-domain granularity may be one of an OFDM symbol level granularity or a transmission slot level granularity.

In some embodiments, where the precoder cycling properties include the frequency-domain granularity, the frequency-domain granularity may be one of a subcarrier group length granularity, and a group of RB size granularity.

In some embodiments, where the precoder cycling properties include the DMRS to RE mapping, the DMRS to RE mapping may be one of (i) an N-port PUSCH and rank-N PUSCH DMRS pattern mapping, where N is an integer greater than 1, and (ii) a 1-port PUSCH and rank-1 PUSCH DMRS pattern mapping.

At step 2040, the UE transmits, to the BS, at least one PUSCH transmission based on (i) the PUSCH antenna port and precoder configuration, (ii) the UL scheduling information, and (iii) the precoder cycling properties.

Although FIG. 20 illustrates one example method for sub-PRB level UL precoder cycling 2000, various changes may be made to FIG. 20. For example, while shown as a series of steps, various steps in FIG. 20 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A method of operating a base station (BS), the method comprising:
receiving, from a user equipment (UE), a UE capability report indicating an antenna configuration of the UE;
transmitting, to the UE, a first message including a physical uplink shared channel (PUSCH) antenna port and precoder configuration for the UE;
transmitting, to the UE, a second message including uplink (UL) scheduling information and precoder cycling properties for the UE; and
receiving, from the UE, at least one PUSCH transmission based on (i) the PUSCH antenna port and precoder configuration, (ii) the UL scheduling information, and (iii) the precoder cycling properties.

2. The method of claim 1, wherein the precoder cycling properties include at least one of:
a precoder type used for precoder cycling;
a time-domain granularity;
a frequency-domain granularity;
a demodulation reference signal (DMRS) to resource element (RE) mapping; and
a cycling pattern.

3. The method of claim 2, wherein the precoder cycling properties include the precoder type, and the precoder type is one of an antenna selection precoder, a codebook based precoder, or a non-codebook based precoder.

4. The method of claim 2, wherein the precoder cycling properties include the time-domain granularity, and the time-domain granularity is one of an OFDM symbol level granularity or a transmission slot level granularity.

5. The method of claim 2, wherein the precoder cycling properties include the frequency-domain granularity, and the frequency-domain granularity is one of a subcarrier group length granularity, and a group of resource block (RB) size granularity.

6. The method of claim 2, wherein the precoder cycling properties include the DMRS to RE mapping, and the DMRS to RE mapping is one of:
an N-port PUSCH and rank-N PUSCH DMRS pattern mapping, where N is an integer greater than 1; and
a 1-port PUSCH and rank-1 PUSCH DMRS pattern mapping.

7. The method of claim 1, wherein the first message is radio resource control (RRC) message, and the second message is a downlink control information (DCI) message.

8. A method of operating a user equipment (UE), the method comprising:
transmitting, to a base station (BS), a UE capability report indicating an antenna configuration of the UE;
receiving, from the BS, a first message including a physical uplink shared channel (PUSCH) antenna port and precoder configuration for the UE;
receiving, from the BS, a second message including uplink (UL) scheduling information and precoder cycling properties for the UE; and
transmitting, to the BS, at least one PUSCH transmission based on (i) the PUSCH antenna port and precoder configuration, (ii) the UL scheduling information, and (iii) the precoder cycling properties.

9. The method of claim 8, wherein the precoder cycling properties include at least one of:
a precoder type used for precoder cycling;
a time-domain granularity;
a frequency-domain granularity;
a demodulation reference signal (DMRS) to resource element (RE) mapping; and
a cycling pattern.

10. The method of claim 9, wherein the precoder cycling properties include the precoder type, and the precoder type is one of an antenna selection precoder, a codebook based precoder, or a non-codebook based precoder.

11. The method of claim 9, wherein the precoder cycling properties include the time-domain granularity, and the time-domain granularity is one of an OFDM symbol level granularity or a transmission slot level granularity.

12. The method of claim 9, wherein the precoder cycling properties include the frequency-domain granularity, and the frequency-domain granularity is one of a subcarrier group length granularity, and a group of resource block (RB) size granularity.

13. The method of claim 9, wherein the precoder cycling properties include the DMRS to RE mapping, and the DMRS to RE mapping is one of:
an N-port PUSCH and rank-N PUSCH DMRS pattern mapping, where N is an integer greater than 1; and
a 1-port PUSCH and rank-1 PUSCH DMRS pattern mapping.

14. An electronic device comprising:
at least on processor including processing circuitry; and
memory storing instructions, wherein the instructions, when executed by the at least one processor individually or collectively, cause the electronic device to:
receive, from a user equipment (UE), a UE capability report indicating an antenna configuration of the UE;
transmit, to the UE, a first message including a physical uplink shared channel (PUSCH) antenna port and precoder configuration for the UE;
transmit, to the UE, a second message including uplink (UL) scheduling information and precoder cycling properties for the UE; and
receive, from the UE, at least one PUSCH transmission based on (i) the PUSCH antenna port and precoder configuration, (ii) the UL scheduling information, and (iii) the precoder cycling properties.

15. The electronic device of claim 14, wherein the precoder cycling properties include at least one of:
a precoder type used for precoder cycling;
a time-domain granularity;
a frequency-domain granularity;
a demodulation reference signal (DMRS) to resource element (RE) mapping; and
a cycling pattern.

16. The electronic device of claim 15, wherein the precoder cycling properties include the precoder type, and the precoder type is one of an antenna selection precoder, a codebook based precoder, or a non-codebook based precoder.

17. The electronic device of claim 15, wherein the precoder cycling properties include the time-domain granularity, and the time-domain granularity is one of an OFDM symbol level granularity or a transmission slot level granularity.

18. The electronic device of claim 15, wherein the precoder cycling properties include the frequency-domain granularity, and the frequency-domain granularity is one of a subcarrier group length granularity, and a group of resource block (RB) size granularity.

19. The electronic device of claim 15, wherein the precoder cycling properties include the DMRS to RE mapping, and the DMRS to RE mapping is one of:
an N-port PUSCH and rank-N PUSCH DMRS pattern mapping, where N is an integer greater than 1; and
a 1-port PUSCH and rank-1 PUSCH DMRS pattern mapping.

20. The electronic device of claim 14, wherein the first message is radio resource control (RRC) message, and the second message is a downlink control information (DCI) message.
